(19) United States
(12) Patent Application Publication
(10) Pub. No.: US 2009/0007690 A1
(43) Pub. Date: Jan. 8, 2009

(54) Method for Metrologically Determining the End of a Test Interval, and Device for Carrying Out Said Method

(75) Inventor: Torsten Hesse, Kleve (DE)

Correspondence Address: HARNESS, DICKEY & PIERCE, P.L.C., P.O. BOX 828, BLOOMFIELD HILLS, MI, 48303, US

(73) Assignee: Ipsen International GmbH, Kleve (DE)

(21) Appl. No.: 12/087,500

(22) PCT Filed: Jan. 15, 2007
(86) PCT No.: PCT/EP2007/000293

§ 371 Date: Jul. 8, 2008

(30) Foreign Application Priority Data
Jan. 14, 2006 (DE) 10 2006 001 911.3

(51) Int. Cl. G01N 3/12

(52) U.S. Cl. 73/799

(57) ABSTRACT

The aim of the invention is to create a method that is as accurate and reliable as possible for metrologically determining the end of a test interval (PI) which is to be maintained to perform a periodical test on pressure vessels (1) subject to load variations within operating cycles (AZ). Said aim is achieved by a method in which the maximum working pressure (p) actually reached inside the pressure vessel (1) per working cycle (AZ) is measured by means of a pressure sensor (2), a load variable (BG) is determined per working cycle (AZ) based on the working pressure (p) measured per working cycle (AZ), a resulting load value (BW) is determined for several successive working cycles (AZ) based on the respective load variables (BG) determined per working cycle (AZ), and the resulting load value (BW) is compared to a predefined comparative value (VG)). A signal indicating that the end of a test interval has been reached is output as soon as the resulting load value (BW) is equal to or greater than the predefined comparative value (VG).

The invention relates to a method for metrologically determining the end of interval of a test interval to be observed for the performance of a periodical test of pressure vessels which are subjected to load variations in working cycles.

From prior art it is known to regularly subject pressure vessels which are subjected to load changes, like for instance overpressure quenching chambers, to material testing, in order to be able to determine fatigue cracks or the like at an early time. These tests which are to be performed on a regular basis are referred to as so-called periodical tests.

For determining the recurrent test periods, i.e. the periodical test intervals, pressure vessels subjected to load variations are normally subjected to an estimation of service life. The service life of a pressure vessel is estimated by a theoretical calculation of the number of load changes which are admissible for a pressure vessel, i.e. the number of admissible working cycles under a design pressure, which design pressure is understood to be the maximum admissible working pressure for the pressure vessel.

For determining the periodical test intervals, a working cycle is usually equated with a load change, namely on the supposition that the pressure vessel is operated under a design pressure during each working cycle. As soon as the half of the load changes which are admissible under a design pressure is reached, the end of the test interval is reached and a periodical test has to be performed.

Although the above-mentioned prior art technique for determining the end of interval of a test interval which has to be observed for the performance of a periodical test of pressure vessels which are subjected to load variations in working cycles is tried and tested in the practice, it is not free of drawbacks, since for determining the periodical test intervals the focus is alone on the number of working cycles which are performed. As a consequence, the test intervals to be observed are set shorter than actually required, which fact results in the disadvantage of unnecessary tests which are time-consuming and expensive.

In view of the above, it is an object of the invention to provide a method which allows to determine as accurately and reliably as possible the end of interval of a test interval to be observed for the performance of a periodical test of pressure vessels subjected to load variations in working cycles.

As a solution of this object the invention provides a method for metrologically determining the end of interval of a test interval to be observed for the performance of a periodical test of pressure vessels subjected to load variations in working cycles, wherein the maximum working pressure actually reached inside the pressure vessel per working cycle is measured by means of a pressure sensor, a load variable is determined per working cycle based on the working pressure measured per working cycle, a resulting load value is determined for several successive subsequent working cycles based on the respective load variables determined per working cycle, and the resulting load value is compared with a predefined comparative value, with a signal indicating that the end of a test interval has been reached being output as soon as the resulting load value is equal to or greater than the predefined comparative value.

Starting point of the method according to the invention is the knowledge that the service life of a pressure vessel, i.e. the number of theoretically admissible working cycles is dependent on the working pressures which are actually reached per working cycle. In accordance with the invention it is therefore proposed to perform the determination of the test interval not on the basis of the theoretically admissible design pressure, but on the basis of the working pressure which is actually reached per working cycle. In this way, unnecessarily short test intervals can be advantageously avoided.

With the method according to the invention it is proposed that in a first step the maximum working pressure which is actually reached inside the pressure vessel is measured by means of a pressure sensor. In a second step a load variable is determined per working cycle based on the working pressure measured per working cycle. This load variable reflects the actual load of the pressure vessel which is obtained as a result of the working pressure actually prevailing during this working cycle and detected by the pressure sensor. Then, in a third step, a resulting load value is determined for several successive subsequent working cycles based on the respective load variables determined per working cycle. The resulting load value accordingly represents in the style of a “collective working load” a dimension for the load on the pressure vessel which is involved as a result of several working cycles, each of which being possibly performed under different working pressures.

In a last step, the resulting load value is compared with a predefined comparative value, wherein a signal indicating that the end of the test interval has been reached is output as soon as the resulting load value is equal to or greater than the predefined comparative value. The periodical test has to be performed by the time of reaching the end of the test interval, hence by the time the resulting load value corresponds to or is greater than the predefined comparative value.

An important advantage of the present invention is that for the determination of the end of interval of a test interval to be observed for the performance of a periodical test of a pressure vessel subjected to load variations in working cycles is not based on the admissible maximum working pressure, i.e. the design pressure, but on the working pressures which are actually prevailing during the individual working cycles. It is possible in this way, to accurately and reliably determine the end of a test interval while simultaneously observing all safety-relevant aspects. Differently from the methods which are known from prior art, the test intervals are not unnecessarily set too short, which is an advantage not least for reasons of cost, since the number of periodical tests can be reduced with regard to the entire service life of a pressure vessel.

According to a further feature of the invention, the load variable is measured by way of the actual working pressure measured per working cycle on one side and the number of working cycles which are theoretically possible at this working pressure on the other side. A pressure vessel for instance which can be operated at a design pressure of 15 bar can be admissibly subjected to 5,500 working cycles at an actual pressure of 10 bar, whereas theoretically 10,000 working cycles are possible at a working pressure of merely 8 bar.

According to a further feature of the invention it is provided that the resulting load value is determined as the sum of all load variables of several successive subsequent working cycles. Hence, the resulting load value is obtained as the sum of all load variables that have been determined per working cycle and thus represents a collective working load for several successive subsequent working cycles.

According to a further feature of the invention it is provided that the comparative value is determined as fractional value of the number of the working cycles which are theoretically possible at a design pressure of the pressure vessel. Here, the fraction is preferably selected to be 0.5. Of course, other fractions are also possible.

According to a further feature of the invention it is provided that a signal indicating that the end of the test interval has been reached is output acoustically and/or visually. It can be provided in addition that when the end of the test interval is reached a continued operation of the vessel is inhibited.

According to a further feature of the invention, the method of the invention is carried out in a computer-assisted fashion, wherein a fully automated operation is preferred. This allows easy handling of the method according to the invention, wherein it can be additionally provided that the currently valid load value and/or the predicted end of the test interval are indicated.

The method according to the invention is particularly suited in connection with vacuum and/or overpressure furnaces which serve for the treatment and particularly the thermal treatment of metallic work pieces. Overpressure quenching chambers represent a particular field of application.

The invention further proposes a device for carrying out the above-described method, said device being characterized by a pressure sensor and a control device. The control device in turn includes a calculation unit as well as a comparing unit.

In accordance with the invention a device is provided in which the pressure sensor measures the maximum pressure that is actually reached inside the pressure vessel per working cycle and outputs a signal corresponding to the measured working pressure to the calculation unit, in which the calculation unit determines a load variable based on the signal delivered from the pressure sensor per working cycle, in which the calculation unit determines a resulting load value based on several load variables, and in which the comparing unit compares the resulting load value determined by the calculation unit with a pre-definable comparative value and outputs a signal in the case of equality and/or exceedance.

In the manner already described above, the device according to the invention makes it possible to determine test intervals or the end thereof accurately and easily, namely in consideration of the actually prevailing working pressures during the individual working cycles.

According to a further feature of the invention it is provided that the control device further includes a storage unit storing the measured working pressures, the load variables determined by the calculation unit, the resulting load value determined by the calculation unit and/or the predefined comparative value. In this way, an execution of the method is possible which can be checked up any time. Moreover, the stored data may be used for statistical purposes or for advance calculations.

According to a further feature of the invention a device is provided in which the comparing unit after each working cycle compares the resulting load value determined by the calculation unit with a predefined comparative value. In this way, after the completion of each working cycle, the current load value can be compared with the predefined comparative value, whereby it is possible to determine by the time of the completion of each working cycle whether the performance of a periodical test is necessary.

Further features and advantages of the invention will become apparent from the following description with reference to the drawing figures, wherein it is shown by:

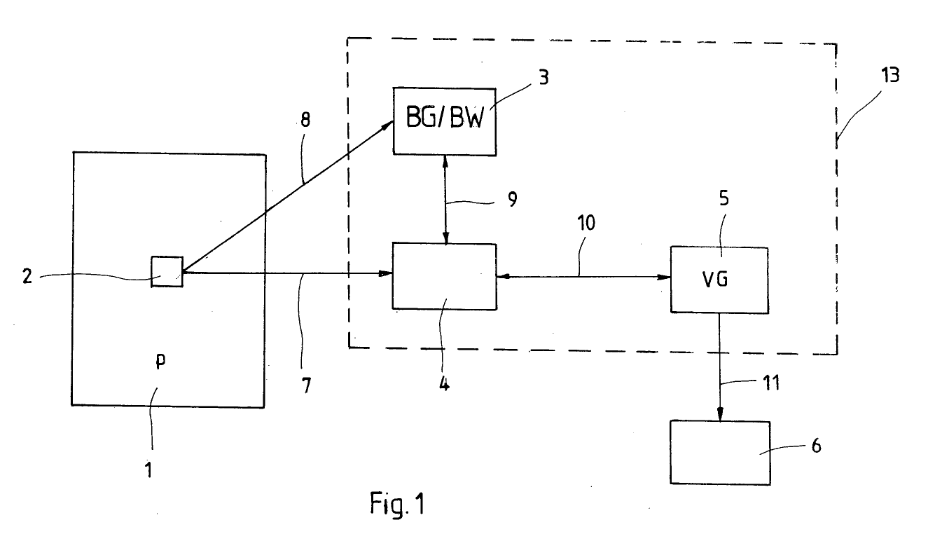

FIG. 1 a schematic representation of the device according to the invention and

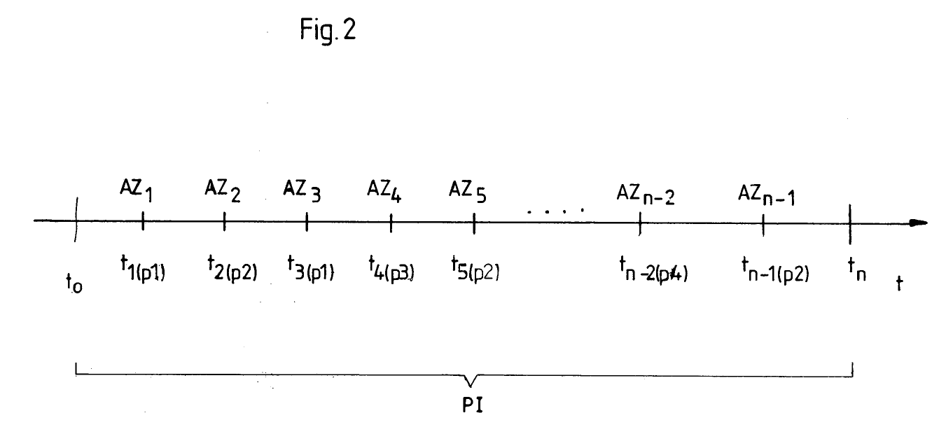

FIG. 2 a time flow chart.

FIG. 1 schematically illustrates the device according to the invention. The same consists of a pressure sensor 2 and a control device 13, which in turn comprises a calculation unit 3, a storage unit 4 as well as a comparing unit 5.

The pressure sensor 2 is arranged inside the pressure vessel 1, for measuring working pressures p prevailing inside the pressure vessel 1.

The control device 13 is arranged outside of the pressure vessel 1 and can be accommodated in a housing not further shown in FIG. 1.

The comparing unit 5 which is also comprised in the control device 13 is connected to a display 6, through a communication link which is represented by an arrow 11 in the illustration of FIG. 1. The display 6 may designed for outputting acoustic and/or visual signals.

The device illustrated in FIG. 1 serves for metrologically determining the end of interval of a test interval PI to be observed for the performance of a periodical test of pressure vessels 1 subjected to load variations within working cycles AZ. This metrological determination is effected as follows:

The maximum working pressure p actually reached inside the pressure vessel 1 per working cycle is measured by means of the pressure sensor 2. The pressure sensor 2 outputs a signal corresponding to the measured working pressure p to the calculation unit 3. The communication link between the pressure sensor 2 and the calculation unit 3 is indicated by arrow 8 in FIG. 1. By means of the calculation unit 3 a load variable BG is determined per working cycle AZ based on the working pressure p measured per working cycle AZ. Then a resulting load value BW is determined on the basis of several load variables BG by means of the computing unit 3. This load value BW further serves to the comparing unit 5 for making a comparison between the load value BW on one side and a predefined comparative value VG on the other side, wherein a signal which indicates that the end of the test interval is reached is output through the display 6 as soon as the resulting load value BW is equal to or greater than the predefined comparative value VG.

The working pressures p measured by the pressure sensor 2, the load variables determined by the calculation unit 3 as well as the load values BW determined by the calculation unit 3 are stored in the embodiment according to FIG. 1 in a storage unit 4. For this purpose, both the pressure sensor 2 and the calculation unit 3 are in a communicating connection with the storage unit 4 as indicated by the arrows 7 and 9 in the illustration according to FIG. 1.

For a comparative consideration of the load value BW delivered by the calculation unit 3 on one side and a predefined comparative value VG on the other side, it can be provided to store also the predefined comparative value VG by means of the storage unit 4 and to provide it both for the calculation unit 3 and the comparing unit 5. In this case, the storage unit 4 and the comparing unit 5 are coupled through a communication link as shown by arrow 10 in the illustration according to FIG. 1.

The method which has been described above with reference to FIG. 1 especially serves to accurately determine the end of interval of a test interval PI to be observed for the performance of a periodical test of pressure vessels 1 subjected to load variations within working cycles AZ dependent on working pressures p actually prevailing within working cycles AZ, so that unnecessarily short test intervals PI can be avoided, which means that periodical tests are not performed more frequently than required.

The method in accordance with the invention will be explained by way of an example:

A pressure vessel 1 subjected to load variations, for instance in the form of an overpressure quenching chamber for metallic work pieces, is designed for a maximum working pressure of 15 bar. This maximum admissible working pressure is referred to as design pressure.

For reasons of safety, the pressure vessel 1 though designed for 15 bar overpressure is operated at maximum of only 14 bar.

If this pressure vessel 1 were operated within each working cycle, i.e. at each start-up and shut-down, at 14 bar overpressure, theoretically a number of load changes of 2,100 would be possible, i.e. the pressure vessel 1 could be subjected to 2,100 load changes at maximum. Based on this, the technique according to prior art which prescribes a periodical test after the half of the possible load cycles would require the performance of a periodical test already after 1,050 cycles.

According to prior art, a periodical test as early as after 1,050 completed cycles has to be performed also in the case where during the individual working cycles AZ the actually prevailing working pressure p is smaller than 14 bar. This will result in the drawback of unnecessarily short test intervals, i.e. the periodical tests are performed unnecessarily often.

The following table shows by way of an example how many load changes are possible at which actual working pressure in a pressure vessel with a design pressure of 15 bar.

| Working pressure p (bar overpressure) | Load changes |
|---|---|
| 14 | 2,100 |
| 13 | 2,600 |
| 12 | 3,500 |
| 11 | 4,200 |
| 10 | 5,500 |
| 9 | 7,300 |
| 8 | 10,000 |
| 7 | 14,000 |
| 5 | 34,000 |
| 3 | 111,000 |
| 1.5 | 470,000 |

From the above table it can be seen that a pressure vessel 1 with a design pressure of 15 bar can stand for instance 5,500 load changes at a pressure of 10 bar, 10,000 load changes at a pressure of 8 bar or 110,000 load changes at a pressure of 3 bar.

When a pressure vessel 1 is subjected to several working cycles at respectively different pressures, the load variable BG is determined per working cycle for each working cycle.

The load variables BG of several successive subsequent working cycles are summed up to a resulting load value BW. Hence, the load value BW is obtained as follows: BW=BG₁+BG₂+BG₃+ . . . +BGₙ.

The load value BW determined in this way is compared with a predefined comparative value VG, with the end of the test interval being reached as soon as the resulting load value BW is equal to or greater than the predefined comparative value VG. The comparative value VG is determined as a fraction of the number of working cycles which are theoretically possible at a design pressure of the pressure vessel 1, with a fraction of 0.5 being the preferred fraction.

For instance, a pressure vessel 1 is subjected to 6,300 working cycles at a pressure of 1.5 bar, 4,000 cycles at a pressure of 5 bar, 2,000 cycles at a pressure of 9 bar, 250 cycles at a pressure of 12 bar, and 50 cycles at a pressure of 14 bar. In this case, the resulting load value BW would be 0.5 (=VG).

Accordingly, in this example a total of 12,600 quenching cycles have been completed until the periodical test. On the other hand, if the full working pressure were applied, as this is the case in prior art, a new test would have been required already after 1,050 cycles.

For further explaining the invention, reference is made to FIG. 2 showing a schematic representation of a flow chart. Plotted on a time bar are the points t₀ and tₙ. At point t₀ a periodical test takes place in the same manner as at point tₙ. Consequently, the test interval PI is between the two points t₀ and tₙ.

Within the test interval PI, the pressure vessel 1 is subjected to various working cycles: At point t₁ to a first working cycle AZ₁ at a working pressure p₁, at point t₂ to a second working cycle AZ₂ at a working pressure p₂, at a third point t₃ to a third working cycle AZ₃ at a working pressure p₁, at a fourth point t₄ to a fourth working cycle AZ₄ at a working pressure p₃ and so on. The actual pressures p prevailing during each working cycle AZ are measured, and a load variable BG is determined per working cycle. The individual load variables BG are summed up to a resulting total load value BW. As soon as this load value exceeds a predefined comparative value, for instance 0.5, the end of the test interval is reached. In the example shown in FIG. 2, this is the case after the final working cycle AZₙ₋₁, for which reason a periodical test has to be performed after the termination of this working cycle.

### LIST OF REFERENCE NUMBERS

1 pressure vessel
2 pressure sensor
3 calculation unit
4 storage unit
5 comparing unit
6 display
7-11 arrow
13 control device
AZ working cycle
PI test interval
t time
p working pressure
BG load variable
BW load value
VG comparative value

1. Method for metrologically determining the end of interval of a test interval to be observed for the performance of a periodical test of pressure vessels subjected to load variations within working cycles, in which method the maximum working pressure actually reached inside the pressure vessel per working cycle is measured by means of a pressure sensor, a load variable is determined per working cycle based on the working pressure measured per working cycle, a resulting load value is determined for several successive subsequent working cycles based on the respective load variables determined per working cycle, and the resulting load value is compared with a predefined comparative value, with a signal indicating that the end of a test interval has been reached being output as soon as the resulting load value is equal to or greater than the predefined comparative value.

2. Method according to claim 1, wherein the load variable per working cycle is determined based on the number of working cycles which are theoretically possible at the pressure measured during this working cycle.

3. Method according to claim 1, wherein the resulting load value is determined as a sum of all the load variables of several successive subsequent working cycles.

4. Method according to claim 1, wherein the comparative value is determined as a fraction of the number of working cycles which are theoretically possible at the design pressure of the pressure vessel.

5. Method according to claim 4, wherein the fraction is selected to be 0.5.

6. Method according to claim 1, wherein a signal indicating that the end of a test interval has been reached is output acoustically and/or visually.

7. Method according to claim 1, wherein it is performed in a computer-assisted fashion.

8. Method according to claim 7, wherein it is performed fully automatically.

9. Device for carrying out the method according to claim 1, comprising a pressure sensor and a control device.

10. Device according to claim 9, wherein the control device includes a calculation unit and a comparing unit.

11. Device according to claim 9, wherein the pressure sensor measures the maximum working pressure actually reached inside the pressure vessel per working cycle and outputs a signal corresponding to the measured working pressure to the calculation unit, that the calculation unit determines a load variable per working cycle based on the signal delivered from the pressure sensor, that the calculation unit determines a resulting load value based on several load variables, and that the comparing unit compares the resulting load value determined by the calculation unit with a predefined comparative value and outputs a signal in the case of equality and/or exceedance.

12. Device according to claim 9, wherein the control device further includes a storage unit storing the measured working pressures, the load variables determined by the calculation unit, the resulting load value determined by the calculation unit, and/or the predefined comparative value.

13. Device according to claim 9, wherein the comparing unit after each working cycle completed compares the resulting load value determined by the calculation unit with a predefined comparative value.

14. Method according to claim 2, wherein the resulting load value is determined as a sum of all the load variables of several successive subsequent working cycles.

15. Device according to claim 10, wherein the pressure sensor measures the maximum working pressure actually reached inside the pressure vessel per working cycle and outputs a signal corresponding to the measured working pressure to the calculation unit, that the calculation unit determines a load variable per working cycle based on the signal delivered from the pressure sensor, that the calculation unit determines a resulting load value based on several load variables, and that the comparing unit compares the resulting load value determined by the calculation unit with a predefined comparative value and outputs a signal in the case of equality and/or exceedance.

16. Device according to claim 10, wherein the control device further includes a storage unit storing the measured working pressures, the load variables determined by the calculation unit, the resulting load value determined by the calculation unit, and/or the predefined comparative value.

17. Device according to claim 11, wherein the control device further includes a storage unit storing the measured working pressures, the load variables determined by the calculation unit, the resulting load value determined by the calculation unit, and/or the predefined comparative value.

18. Device according to claim 10, in which the comparing unit after each working cycle completed compares the resulting load value determined by the calculation unit with a predefined comparative value.

19. Device according to claim 11, in which the comparing unit after each working cycle completed compares the resulting load value determined by the calculation unit with a predefined comparative value.

20. Device according to claim 12, in which the comparing unit after each working cycle completed compares the resulting load value determined by the calculation unit with a predefined comparative value.
